(19) United States
(12) Patent Application Publication
(10) Pub. No.: US 2025/0319478 A1
(43) Pub. Date: Oct. 16, 2025

(54) ENHANCED FLOTATION METHOD OF LEPIDOLITE ORE BASED ON HIGH-ENTROPY COLLECTION

(71) Applicant: Kunming University of Science and Technology, Kunming City (CN)

(72) Inventors: Qicheng Feng, Kunming City (CN); Shuming Wen, Kunming City (CN); Yanyu Tang, Kunming City (CN); Guang Han, Kunming City (CN); Wenhang Yang, Kunming City (CN); Wenjuan Zhao, Kunming City (CN)

(21) Appl. No.: 19/005,477

(22) Filed: Dec. 30, 2024

(30) Foreign Application Priority Data
Apr. 12, 2024 (CN) 202410438104.4

(51) Int. Cl. B03D 1/01; B03D 1/018

(52) U.S. Cl. CPC B03D 1/01; B03D 1/018; B03D 2201/007; B03D 2203/04

(57) ABSTRACT

An enhanced flotation method of lepidolite ore based on high-entropy collection is provided for mineral processing. Concerning problems of conventional lepidolite collectors, such as low collection ability, poor selectivity, and large consumption, based on thermodynamic theory of complex multiphase solid-liquid systems, by adjusting and controlling the adsorption equilibrium constant of collector(s) on a surface of lepidolite and gangue minerals and entropy change during adsorption process, a high-entropy collector suitable for efficient separation of lepidolite is developed. Without changing conventional flotation procedures, enhanced flotation of lepidolite could be achieved only by adding sodium carbonate as a modifying agent with a low amount of the high-entropy collector.

### CROSS REFERENCE TO RELATED APPLICATION

This patent application claims the benefit and priority of Chinese Patent Application No. 202410438104.4, entitled “ENHANCED FLOTATION METHOD OF LEPIDOLITE ORE BASED ON HIGH ENTROPY COLLECTION” filed on Apr. 12, 2024, the disclosure of which is incorporated by reference herein in its entirety as part of the present application.

### TECHNICAL FIELD

The present disclosure relates to an enhanced flotation method of lepidolite ore based on high-entropy collection, belonging to the technical field of mineral processing.

### BACKGROUND

The efficient development and utilization of existing lithium ore resources are very necessary and significant under the pressure from both resource requirements and resource security.

Lepidolite, a common lithium mineral, is a lithium-and potassium-based aluminosilicate often containing rubidium and cesium, which is an important raw material for the extraction of these rare metals and is mainly found in granite pegmatite. Flotation is the main method for enriching lepidolite ores, including flotation methods using a cationic collector, an anionic collector, or an anion-cation combined collector. The flotation method employing a cationic collector uses an amine-based reagent as a lepidolite collector and is used for production under a highly acidic flotation environment. However, highly-acidic pulp has drawbacks of high anti-corrosion requirements for various equipment, great potential safety hazards, poor operating environment, and high costs for recycled water treatment. Moreover, amine-based collectors have strong foaming performance to produce large amounts of flotation foam, and exhibits high viscosity and poor fluidity. The flotation method employing an anionic collector uses fatty acids, sulfonic acids and derivatives thereof as lepidolite collectors; however, using a single collector has some problems, such as large consumption, poor adaptability to temperature and slime, and low concentrate indexes. The flotation method employing an anion-cation combined collector utilizes the synergistic effect of cationic and anionic collectors to reduce the critical micelle concentration of the collectors and the surface tension of the solution so as to improve the activity of the collectors, thereby increasing their selectivity to lepidolite and their collection ability. However, it is usually necessary to add large amounts of inhibitors to inhibit gangue minerals in the ore, and these inhibitors have a strong dispersion effect on the pulp, which makes the settling of the pulp difficult; in addition, the anion-cation combined collectors are sensitive to slime and are not suitable for handling lepidolite ores with a high mud content.

Therefore, there is an urgent need to develop a new lepidolite collector with both collection ability and selectivity, which not only could increase the hydrophobic difference between lepidolite and gangue minerals, but also could optimize the flotation foam, thus achieving the efficient separation of lepidolite ore and providing technical supports for the low-carbon development and comprehensive utilization of lithium ore resources.

### SUMMARY

Concerning the problems of conventional lepidolite collectors such as low collection ability, poor selectivity, and large consumption, the present disclosure proposes an enhanced flotation method of lepidolite ore based on high-entropy collection. Based on the thermodynamic theory of a complex multiphase solid-liquid system, by adjusting and controlling the adsorption equilibrium constant of the collector on the surface of lepidolite and gangue minerals and the entropy change during the adsorption process, the present disclosure develops a high-entropy collector suitable for efficient separation of lepidolite, which could achieve the enhanced flotation recovery of lepidolite only by adding sodium carbonate as a modifying agent in conventional flotation procedures.

The enhanced flotation method of lepidolite ore based on high-entropy collection includes the following steps:
(1) grinding lepidolite ore until a mass percentage content of resulting particles with a particle size of less than 74 μm is in a range of 40-50%, and pulping to obtain a lepidolite flotation pulp with a mass percentage concentration of 30-40%;
(2) sequentially adding a modifying agent and a high-entropy collector to the lepidolite flotation pulp obtained in step (1), and subjecting a resulting mixture to rougher flotation, to obtain a roughed concentrate and roughed tailings;
(3) sequentially adding the modifying agent and the high-entropy collector to the roughed tailings obtained in step (2) to obtain a mixture, and subjecting the mixture to a primary scavenger operation to obtain a primary scavenged concentrate and primary scavenged tailings, wherein the primary scavenged concentrate is returned to pulping and is then subjected to the rougher flotation;
(4) sequentially adding the modifying agent and the high-entropy collector to the primary scavenged tailings obtained in step (3), and subjecting an obtained mixture to a secondary scavenger operation to obtain a secondary scavenged concentrate and secondary scavenged tailings, the secondary scavenged tailings being flotation tailings, wherein the secondary scavenged concentrate is returned to pulping and is then subjected to the primary scavenger operation;
(5) adding the high-entropy collector to the roughed concentrate obtained in step (2), and subjecting a resulting system to a primary cleaner to obtain a primary cleaned concentrate and primary cleaned tailings, wherein the primary cleaned tailings are returned to pulping and are then subjected to the rougher flotation; and
(6) subjecting the primary cleaned concentrate obtained in step (5) to a secondary cleaner to obtain a secondary cleaned concentrate and secondary cleaned tailings, the secondary cleaned concentrate being a lepidolite concentrate, wherein the secondary cleaned tailings are returned to pulping and are then subjected to the primary cleaner;
wherein the high-entropy collector is a mixture of cocoamine, dodecanamidopropyldimethyl ammonium chloride, sodium lauryl sulfate, sodium laureth sulfate, and mineral oil.

In some embodiments, a mass percentage content of Li₂O in the lepidolite ore of step (1) is in a range of 0.29-0.81%.

In some embodiments, relative to per ton of the lepidolite ore, 640-960 g of the modifying agent and 320-480 g of the high-entropy collector are added to the lepidolite flotation pulp for the rougher flotation of step (2).

In some embodiments, relative to per ton of the lepidolite ore, 320-480 g of the modifying agent and 160-240 g of the high-entropy collector are added to the roughed tailings for the primary scavenger operation of step (3).

In some embodiments, relative to per ton of the lepidolite ore, 80-120 g of the modifying agent and 40-60 g of the high-entropy collector are added to the primary scavenged tailings for the secondary scavenger operation of step (4).

In some embodiments, relative to per ton of the lepidolite ore, 60-80 g of the high-entropy collector is added to the roughed concentrate for the primary cleaner of step (5).

In some embodiments, based on a mass of the high-entropy collector being 100%, the cocoamine accounts for 26-32%, the dodecanamidopropyldimethyl ammonium chloride accounts for 6-16%, the sodium lauryl sulfate accounts for 32-42%, the sodium laureth sulfate accounts for 8-18%, and the mineral oil accounts for 6-12%.

In some embodiments, the modifying agent is sodium carbonate.

The principle of the present disclosure is as follows:

Flotation is a physicochemical behavior occurring at the solid-liquid interface, and the adsorption process of the collector at the mineral interface is a spontaneous process. Based on the second law of thermodynamics, the spontaneous process of an isolated system always proceeds in the direction of increasing entropy. As such, the entropy change of the collector adsorption process at the lepidolite flotation interface is greater than zero and the change of Gibbs free energy change is less than zero. When the collector interacts with the lepidolite surface, the entropy change of the collector adsorbed on the surface of lepidolite could be calculated according to the following equation:

$$Δ S = - R {\sum }_{i = 1}^{k} {x}_{i} ln {x}_{i}$$

where, ΔS represents the collection entropy change on the surface of lepidolite; R is the gas constant; and xᵢ is a mole fraction of the i-th collector on the surface of lepidolite. With the measurement of the adsorption amount of various collectors on the surface of lepidolite, the xᵢ value and adsorption equilibrium constants of various collectors could be calculated, such that the entropy change of the collectors adsorbed on the surface of lepidolite could be calculated, so as to assess the adsorption ability and selectivity of different collectors on the surface of lepidolite. It can be seen therefrom that increasing the type of collectors could significantly increase the adsorption entropy change of collectors, such that the adsorption activity and adsorption efficiency of the collectors on the surface of lepidolite and the stability of the adsorption layer are improved, thereby improving the flotation effect on lepidolite. This is the physical nature of the synergistic effect achieved by combining multiple collectors. Therefore, the combined use of cocoamine, dodecanamidopropyldimethyl ammonium chloride, sodium lauryl sulfate, sodium laureth sulfate, and mineral oil enables high-entropy collection of lepidolite and improves the separation effect on lepidolite.

Embodiments of the present disclosure have the following beneficial effects.
(1) By constructing a high-entropy collection system, the present disclosure enables the process of the interaction between the lepidolite surface and reagents to achieve a high collection entropy, thus improving the adsorption activity and adsorption efficiency of the collector on the surface of the lepidolite and the stability of the adsorption layer, which enhances the hydrophobicity of the lepidolite surface, optimizes the froth structure during flotation and the mineral loading capacity, and thus promotes the efficient flotation recovery of lepidolite, thereby overcoming the problem of poor flotation effects of conventional collectors.
(2) By adjusting and controlling the adsorption equilibrium constant of the collector on the surface of the lepidolite and gangue minerals and the entropy change of the adsorption process, the present disclosure enables the collector to be selectively adsorbed on the surface of lepidolite, which increases the difference in hydrophobicity between the lepidolite and gangue minerals, and improves the separation indexes of the lepidolite ore, thereby solving the problems of similar surface properties of lepidolite and gangue minerals, small floatability difference, and great separation difficulty.
(3) The present disclosure increases the adsorption entropy change of the collectors on the surface of the lepidolite by increasing the type of collectors, such that the amount of the collectors to be used is reduced, thereby achieving the enhanced flotation of the lepidolite ore only by adding sodium carbonate as a modifying agent without changing conventional flotation procedures.
(4) The high-entropy collector used in the present disclosure is green and non-toxic, with simple preparation processes, stable performance, use convenience, and great controllability. Based on the physical nature of the synergistic effect of multiple collectors, it economically and efficiently solves the problems of conventional lepidolite collectors, such as low collection ability, poor selectivity, and large consumption, thereby opening up a new way for efficient separation and comprehensive utilization of complex and difficult-to-handle lithium ore resources.

### BRIEF DESCRIPTION OF THE DRAWINGS

FIG. 1 shows a flowchart of the process according to an embodiment of the present disclosure.

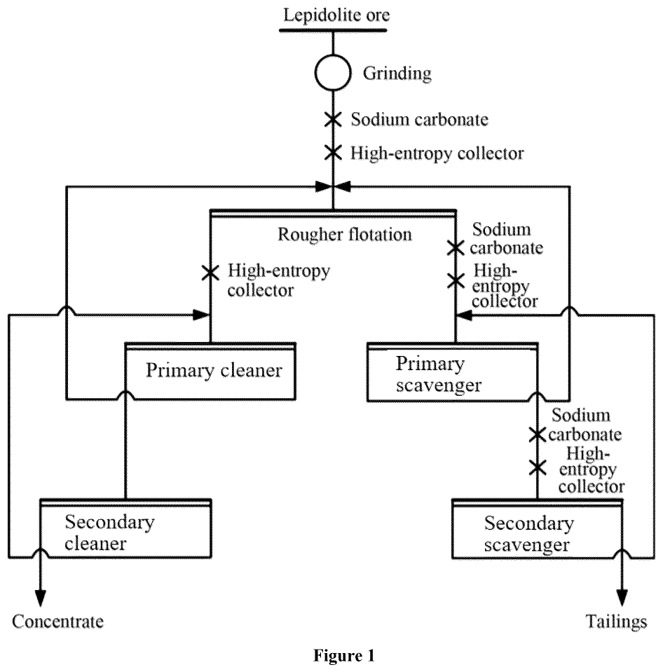

### DETAILED DESCRIPTION OF THE EMBODIMENTS

The present disclosure will be further described in details in conjunction with the following specific embodiments, but the scope of the present disclosure is not limited thereto.

In the following examples of the present disclosure, the modifying agent was sodium carbonate, and high-entropy collector was a mixture of cocoamine, dodecanamidopropyldimethyl ammonium chloride, sodium lauryl sulfate, sodium laureth sulfate, and mineral oil.

### EXAMPLE 1

In this example, based on the mass of the high-entropy collector being 100%, there was 26% of cocoamine, 16% of dodecanamidopropyldimethyl ammonium chloride, 42% of sodium lauryl sulfate, 8% of sodium laureth sulfate, and 8% of mineral oil.

As shown in FIGURE, an enhanced flotation method of lepidolite ore based on high-entropy collection was performed as follows:
(1) The lepidolite ore was ground until the mass percentage content of resulting particles with a particle size of less than 74 um was 40%, followed by pulping to obtain a lepidolite flotation pulp with a mass percentage concentration of 30%, with the mass percentage content of Li₂O in the lepidolite ore being 0.29%.
(2) A modifying agent and a high-entropy collector were sequentially added to the lepidolite flotation pulp obtained in step (1), and a resulting mixture was subjected to rougher flotation to obtain a roughed concentrate and roughed tailings, in which, relative to per ton of the lepidolite ore, 640 g of the modifying agent and 320 g of the high-entropy collector were added to the lepidolite flotation pulp for the rougher flotation.
(3) The modifying agent and the high-entropy collector were sequentially added to the roughed tailings obtained in step (2) to obtain a mixture, and the mixture was subjected to a primary scavenger operation to obtain a primary scavenged concentrate and primary scavenged tailings, where the primary scavenged concentrate was returned to pulping and was then subjected to the rougher flotation; and relative to per ton of the lepidolite ore, 320 g of the modifying agent and 160 g of the high-entropy collector were added to the roughed tailings for the primary scavenger operation.
(4) The modifying agent and the high-entropy collector were sequentially added to the primary scavenged tailings obtained in step (3), and an obtained mixture was subjected to a secondary scavenger operation to obtain a secondary scavenged concentrate and secondary scavenged tailings, with the secondary scavenged tailings being flotation tailings; where the secondary scavenged concentrate was returned to pulping and was then subjected to the primary scavenger operation; and relative to per ton of the lepidolite ore, 80 g of the modifying agent and 40 g of the high-entropy collector were added to the primary scavenged tailings for the secondary scavenger operation.
(5) The high-entropy collector was added to the roughed concentrate obtained in step (2), and a resulting mixture was subjected to a primary cleaner to obtain a primary cleaned concentrate and primary cleaned tailings, where the primary cleaned tailings were returned to pulping and were then subjected to the rougher flotation; where relative to per ton of the lepidolite ore, 60 g of the high-entropy collector was added to the roughed concentrate for the primary cleaner of step (5).
(6) The primary cleaned concentrate obtained in step (5) was subjected to a secondary cleaner to obtain a secondary cleaned concentrate and secondary cleaned tailings, with the secondary cleaned concentrate being a lepidolite concentrate; where the secondary cleaned tailings were returned to pulping and were then subjected to the primary cleaner.

The flotation recovery of lithium in this example was 88.2%.

### EXAMPLE 2

In this example, based on the mass of the high-entropy collector being 100%, there was 32% of cocoamine, 6% of dodecanamidopropyldimethyl ammonium chloride, 32% of sodium lauryl sulfate, 18% of sodium laureth sulfate, and 12% of mineral oil.

As shown in FIGURE, an enhanced flotation method of lepidolite ore based on high-entropy collection was performed as follows:
(1) The lepidolite ore was ground until the mass percentage content of resulting particles with a particle size of less than 74 um was 45%, followed by pulping to obtain a lepidolite flotation pulp with a mass percentage concentration of 35%, with the mass percentage content of Li₂O in the lepidolite ore being 0.55%.
(2) A modifying agent and a high-entropy collector were sequentially added to the lepidolite flotation pulp obtained in step (1), and a resulting mixture was subjected to rougher flotation to obtain a roughed concentrate and roughed tailings; in which, relative to per ton of the lepidolite ore, 800 g of the modifying agent and 400 g of the high-entropy collector were added to the lepidolite flotation pulp for the rougher flotation.
(3) The modifying agent and the high-entropy collector were sequentially added to the roughed tailings obtained in step (2) to obtain a mixture, and the mixture was subjected to a primary scavenger operation to obtain a primary scavenged concentrate and primary scavenged tailings, where the primary scavenged concentrate was returned to pulping and was then subjected to the rougher flotation; in which, relative to per ton of the lepidolite ore, 400 g of the modifying agent and 200 g of the high-entropy collector were added to the roughed tailings for the primary scavenger operation.
(4) The modifying agent and the high-entropy collector were sequentially added to the primary scavenged tailings obtained in step (3), and an obtained mixture was subjected to a secondary scavenger operation to obtain a secondary scavenged concentrate and secondary scavenged tailings, with the secondary scavenged tailings being flotation tailings; where the secondary scavenged concentrate was returned to pulping and was then subjected to the primary scavenger operation; and relative to per ton of the lepidolite ore, 100 g of the modifying agent and 50 g of the high-entropy collector were added to the primary scavenged tailings for the secondary scavenger operation.
(5) The high-entropy collector was added to the roughed concentrate obtained in step (2), and a resulting mixture was subjected to a primary cleaner to obtain a primary cleaned concentrate and primary cleaned tailings, where the primary cleaned tailings were returned to pulping and were then subjected to the rougher flotation; and relative to per ton of the lepidolite ore, 70 g of the high-entropy collector was added to the roughed concentrate for the primary cleaner of step (5).
(6) The primary cleaned concentrate obtained in step (5) was subjected to a secondary cleaner to obtain a secondary cleaned concentrate and secondary cleaned tailings, with the secondary cleaned concentrate being a lepidolite concentrate; where the secondary cleaned tailings were returned to pulping and were then subjected to the primary cleaner.

The flotation recovery of lithium in this example was 90.6%.

### EXAMPLE 3

In this example, based on the mass of the high-entropy collector being 100%, there was 30% of cocoamine, 12% of dodecanamidopropyldimethyl ammonium chloride, 38% of sodium lauryl sulfate, 14% of sodium laureth sulfate, and 6% of mineral oil.

As shown in FIGURE, an enhanced flotation method of lepidolite ore based on high-entropy collection was performed as follows:
(1) The lepidolite ore was ground until the mass percentage content of resulting particles with a particle size of less than 74 um was 50%, followed by pulping to obtain a lepidolite flotation pulp with a mass percentage concentration of 40%, with the mass percentage content of Li₂O in the lepidolite ore being 0.81%.
(2) A modifying agent and a high-entropy collector were sequentially added to the lepidolite flotation pulp obtained in step (1), and a resulting mixture was subjected to rougher flotation to obtain a roughed concentrate and roughed tailings; in which, relative to per ton of the lepidolite ore, 960 g of the modifying agent and 480 g of the high-entropy collector were added to the lepidolite flotation pulp for the rougher flotation.
(3) The modifying agent and the high-entropy collector were sequentially added to the roughed tailings obtained in step (2) to obtain a mixture, and the mixture was subjected to a primary scavenger operation to obtain a primary scavenged concentrate and primary scavenged tailings, where the primary scavenged concentrate was returned to pulping and was then subjected to the rougher flotation; and relative to per ton of the lepidolite ore, 480 g of the modifying agent and 240 g of the high-entropy collector were added to the roughed tailings for the primary scavenger operation.
(4) The modifying agent and the high-entropy collector were sequentially added to the primary scavenged tailings obtained in step (3), and an obtained mixture was subjected to a secondary scavenger operation to obtain a secondary scavenged concentrate and secondary scavenged tailings, with the secondary scavenged tailings being flotation tailings; where the secondary scavenged concentrate was returned to pulping and was then subjected to the primary scavenger operation; and relative to per ton of the lepidolite ore, 120 g of the modifying agent and 60 g of the high-entropy collector were added to the primary scavenged tailings for the secondary scavenger operation.
(5) The high-entropy collector was added to the roughed concentrate obtained in step (2), and a resulting mixture was subjected to a primary cleaner to obtain a primary cleaned concentrate and primary cleaned tailings, where the primary cleaned tailings were returned to pulping and were then subjected to the rougher flotation; and relative to per ton of the lepidolite ore, 80 g of the high-entropy collector was added to the roughed concentrate for the primary cleaner of step (5).
(6) The primary cleaned concentrate obtained in step (5) was subjected to a secondary cleaner to obtain a secondary cleaned concentrate and secondary cleaned tailings, with the secondary cleaned concentrate being a lepidolite concentrate; where the secondary cleaned tailings were returned to pulping and were then subjected to the primary cleaner.

The flotation recovery of lithium in this example was 92.1%.

The specific embodiments of the present disclosure have been described in detail above, but the present disclosure is not limited thereto. Various changes could be made within the knowledge scope of those of ordinary skill in the art without departing from the spirit of the present disclosure.

What is claimed is:

1. An enhanced flotation method of lepidolite ore based on high-entropy collection, comprising:
(1) grinding lepidolite ore until a mass percentage content of resulting particles with a particle size of less than 74 μm is in a range of 40-50%, and pulping to obtain a lepidolite flotation pulp with a mass percentage concentration of 30-40%;
(2) sequentially adding a modifying agent and a high-entropy collector to the lepidolite flotation pulp obtained in step (1), and subjecting a resulting mixture to rougher flotation to obtain a roughed concentrate and roughed tailings;
(3) sequentially adding the modifying agent and the high-entropy collector to the roughed tailings obtained in step (2) to obtain a mixture, and subjecting the mixture to a primary scavenger operation to obtain a primary scavenged concentrate and primary scavenged tailings, wherein the primary scavenged concentrate is returned to pulping and is then subjected to the rougher flotation;
(4) sequentially adding the modifying agent and the high-entropy collector to the primary scavenged tailings obtained in step (3), and subjecting an obtained mixture to a secondary scavenger operation to obtain a secondary scavenged concentrate and secondary scavenged tailings, the secondary scavenged tailings being flotation tailings, wherein the secondary scavenged concentrate is returned to pulping and is then subjected to the primary scavenger operation;
(5) adding the high-entropy collector to the roughed concentrate obtained in step (2), and subjecting a resulting system to a primary cleaner to obtain a primary cleaned concentrate and primary cleaned tailings, wherein the primary cleaned tailings are returned to pulping and are then subjected to the rougher flotation; and
(6) subjecting the primary cleaned concentrate obtained in step (5) to a secondary cleaner to obtain a secondary cleaned concentrate and secondary cleaned tailings, the secondary cleaned concentrate being a lepidolite concentrate, wherein the secondary cleaned tailings are returned to pulping and are then subjected to the primary cleaner;
wherein the high-entropy collector is a mixture of cocoamine, dodecanamidopropyldimethyl ammonium chloride, sodium lauryl sulfate, sodium laureth sulfate, and mineral oil.

2. The enhanced flotation method of lepidolite ore based on high-entropy collection as claimed in claim 1, wherein a mass percentage content of Li₂O in the lepidolite ore in step (1) is in a range of 0.29-0.81%.

3. The enhanced flotation method of lepidolite ore based on high-entropy collection as claimed in claim 1, wherein relative to per ton of the lepidolite ore, 640-960 g of the modifying agent and 320-480 g of the high-entropy collector are added to the lepidolite flotation pulp for the rougher flotation of step (2).

4. The enhanced flotation method of lepidolite ore based on high-entropy collection as claimed in claim 1, wherein relative to per ton of the lepidolite ore, 320-480 g of the modifying agent and 160-240 g of the high-entropy collector are added to the roughed tailings for the primary scavenger operation of step (3).

5. The enhanced flotation method of lepidolite ore based on high-entropy collection as claimed in claim 1, wherein relative to per ton of the lepidolite ore, 80-120 g of the modifying agent and 40-60 g of the high-entropy collector are added to the primary scavenged tailings for the secondary scavenger operation of step (4).

6. The enhanced flotation method of lepidolite ore based on high-entropy collection as claimed in claim 1, wherein relative to per ton of the lepidolite ore, 60-80 g of the high-entropy collector is added to the roughed concentrate for the primary cleaner of step (5).

7. The enhanced flotation method of lepidolite ore based on high-entropy collection as claimed in claim 1, wherein based on a mass of the high-entropy collector being 100%, the cocoamine accounts for 26-32%, the dodecanamidopropyldimethyl ammonium chloride accounts for 6-16%, the sodium lauryl sulfate accounts for 32-42%, the sodium laureth sulfate accounts for 8-18%, and the mineral oil accounts for 6-12%.

8. The enhanced flotation method of lepidolite ore based on high-entropy collection as claimed in claim 1, wherein the modifying agent is sodium carbonate.
